(19) United States
(12) Patent Application Publication
(10) Pub. No.: US 2009/0109384 A1
(43) Pub. Date: Apr. 30, 2009

(54) ARRAY SUBSTRATE AND DISPLAY PANEL HAVING THE SAME

(75) Inventors: Su-Jeong Kim, Seoul (KR); Kwang-Hyun Kim, Guri-si (KR); Nam-Seok Lee, Suwon-si (KR); Jeong-Uk Heo, Seongnam-si (KR); Ji-Yoon Jung, Cheonan-si (KR)

Correspondence Address: CANTOR COLBURN, LLP, 20 Church Street, 22nd Floor, Hartford, CT, 06103, US

(73) Assignee: Samsung Electronics Co., Ltd, Suwon-si (KR)

(21) Appl. No.: 12/138,929

(22) Filed: Jun. 13, 2008

(30) Foreign Application Priority Data
Oct. 29, 2007 (KR) 10-2007-0108792

(51) Int. Cl. G02F 1/1335

(52) U.S. Cl. 349/106

(57) ABSTRACT

An array substrate includes: a gate line, a data line crossing disposed substantially perpendicular to the gate line, a first switching element being electrically connected to the gate line and the data line, a pixel electrode being electrically connected to the first switching element to be formed in a pixel area, the pixel electrode having including an opening pattern, and a light-blocking wiring formed disposed in correspondence with the opening pattern is formed, the light-blocking wiring including a convex-concave pattern.

This application claims priority to Korean Patent Application No. 2007-108792, filed on Oct. 29, 2007, and all the benefits accruing therefrom under 35 U.S.C. §119, the contents of which in its entirety are herein incorporated by reference.

### BACKGROUND OF THE INVENTION

1. Field of the Invention

The present invention relates to an array substrate and a display panel having the array substrate. More particularly, the present invention relates to an array substrate adapted to a liquid crystal display (“LCD”) device and a display panel having the array substrate.

2. Description of the Related Art

Generally, a liquid crystal display (“LCD”) panel includes an array substrate, an opposite substrate and a liquid crystal layer. The array substrate includes a plurality of switching elements such as thin-film transistors (“TFTs”) for driving each of a plurality of pixel areas, and a plurality of pixel electrodes electrically connected to the TFTs. The opposite substrate faces the array substrate and includes a plurality of color filters. The liquid crystal layer is interposed between the array substrate and the opposite substrate.

The liquid crystal layer includes liquid crystal molecules having optical and electrical properties, such as an anisotropic refractive index and an anisotropic dielectric constant. When a data voltage is applied to a pixel electrode of the array substrate, electric fields are generated between the pixel electrode and a common electrode of the opposite substrate to alter an orientation of the liquid crystal molecules in the liquid crystal layer. When the orientation of the liquid crystal molecules is altered, optical transmissivity of the liquid crystal layer is changed. This property of liquid crystals may be used to display an image. In order to enhance a viewing angle of the LCD panel, a patterned vertical alignment (“PVA”) mode LCD device has been developed, which has an opening pattern formed in the pixel electrode. Recently, the pixel electrode has been divided into two sub-electrodes to realize the PVA mode LCD device, so that different voltages may be applied to the two sub-electrodes, respectively. In order to apply the different voltages to the sub-electrodes, a couple of different TFTs or a TFT and a voltage up capacitor may be used.

In an array substrate having a pixel electrode including a plurality of sub-electrodes, an aperture ratio is decreased in an area where the sub-electrodes are spaced apart from each other. In order to increase the aperture ratio, a metal pattern connected to a storage line is formed in the spaced area.

However, liquid crystal molecules adjacent to the metal pattern are slanted. Particularly, when the metal pattern is formed in a slant direction with respect to a gate line of a pixel area, the liquid crystal molecules are arranged in the metal pattern so that a direction of the liquid crystal molecules is distorted with respect to a polarizing axis. Therefore, a backlight provided from a lower portion of the LCD panel leaks through the spaced area, thereby generating light leakage. The light leakage may decrease the display quality of the LCD panel.

### BRIEF SUMMARY OF THE INVENTION

An exemplary embodiment of the present invention provides an array substrate which enhances display quality by minimizing light leakage.

Exemplary embodiments of the present invention also provide a display panel having the above-mentioned exemplary embodiment of an array substrate.

In an exemplary embodiment of the present invention, an array substrate includes; a gate line, a data line crosses the gate line, a first switching element electrically connected to the gate line and the data line, a pixel electrode electrically connected to the first switching element, the pixel electrode including an opening pattern, and a light-blocking wiring disposed in correspondence with the opening pattern. The light-blocking wiring includes a convex-concave pattern.

In one exemplary embodiment, the opening pattern and the light-blocking wiring may be disposed in a diagonal line direction with respect to the gate line, when viewed from a plan view.

In one exemplary embodiment, a shape of the opening pattern may be substantially equal to that of the light-blocking wiring.

In one exemplary embodiment, the convex-concave pattern may be disposed on at least one of a first edge portion of the light-blocking wiring and a second edge portion of the light-blocking wiring substantially opposite to the first edge portion, when viewed from a plan view.

In one exemplary embodiment, the array substrate may further include a storage line disposed such that the pixel electrode overlaps at least a portion thereof, the storage being electrically connected to the light-blocking wiring.

In another exemplary embodiment of the present invention, an array substrate includes; first and second gate lines disposed on a base substrate, a data line disposed substantially perpendicular to the first and second gate lines, a pixel electrode including a first sub-electrode and a second sub-electrode spaced apart from the first sub-electrode by an opening pattern formed in a diagonal direction with respect to the first and second gate lines, a storage line overlapped by the first and second sub-electrodes, wherein sections of the storage line may be disposed substantially in parallel with one of the first and second gate lines and the data line, a light-blocking wiring disposed in correspondence with the opening pattern, wherein the light-blocking wiring may be electrically connected to the storage line, the convex concave wiring including a concave-convex pattern, a dual switching element electrically connected to the first gate line and the data line, the dual switching element including a first drain electrode which contacts the second sub-electrode, and a switching element electrically connected dot the second gate line and the data line, the switching element including a source electrode which contacts the second sub-electrode and a third drain electrode which is overlapped by the first sub-electrode.

In still another exemplary embodiment of the present invention, a display panel includes; an array substrate including a switching element electrically connected to a gate line disposed on a base substrate and a data line disposed on the base substrate, a pixel electrode electrically connected to the switching element, the pixel electrode having a first opening pattern formed thereon in a diagonal line with respect to the gate line, and a light-blocking wiring disposed in correspondence with the opening pattern, the light-blocking wiring including a concave-convex pattern having a first slant part and a second slant part disposed at an angle to each other, and an opposite substrate disposed substantially opposite to the array substrate, the opposite substrate including a common electrode having a second opening pattern formed thereon, wherein the second opening pattern defines a liquid crystal domain with the first opening pattern.

In one exemplary embodiment, the angle between the first slant portion and the second slant portion may be about 60 degrees to about 120 degrees.

In one exemplary embodiment, the display panel may further include a first polarizing plate attached to the array substrate, the first polarizing plate having a first polarizing axis, and a second polarizing plate attached to the opposite substrate, the second polarizing plate having a second polarizing axis substantially perpendicular to the first polarizing axis, wherein the first slant portion is disposed at an angle of about 0 degrees to about 45 degrees with respect to the first polarizing axis, and the second slant portion is disposed at an angle of about 0 degrees to about 45 degrees with respect to the second polarizing axis at an angle of about 0 degree to about 45 degrees.

According to an exemplary embodiment of an array substrate and an exemplary embodiment of a display panel having the exemplary embodiment of an array substrate, a light-blocking wiring is disposed in correspondence with an opening pattern, thereby aligning liquid crystal molecules in a direction of a polarizing axis. Therefore, light leakage is minimized and a contrast ratio of the display panel is increased, so that display quality may be enhanced.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating an exemplary embodiment of a display panel according to the present invention;

FIG. 2 is an enlarged plan view illustrating an exemplary embodiment of a light-blocking wiring of FIG. 1;

FIG. 3 is an enlarged plan view illustrating a position between an exemplary embodiment of a light-blocking wiring and an exemplary embodiment of a pixel electrode of FIG. 2;

FIGS. 4 to 9 are enlarged plan views illustrating exemplary embodiments of a light-blocking wiring according to the present invention;

FIG. 10 is a cross-sectional view taken along line I-I′ and line II-II′ of FIG. 1;

FIGS. 11A and 15 are plan views illustrating an exemplary embodiment of a method of manufacturing an exemplary embodiment of an array substrate as illustrated in FIGS. 1 and 10;

FIGS. 11B, 12, 13 and 14 are cross-sectional views illustrating an exemplary embodiment of an array substrate of FIG. 10; and

FIG. 16 is a plan view illustrating another exemplary embodiment of an array substrate according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element or layer, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in more detail with reference to the accompanying drawings.

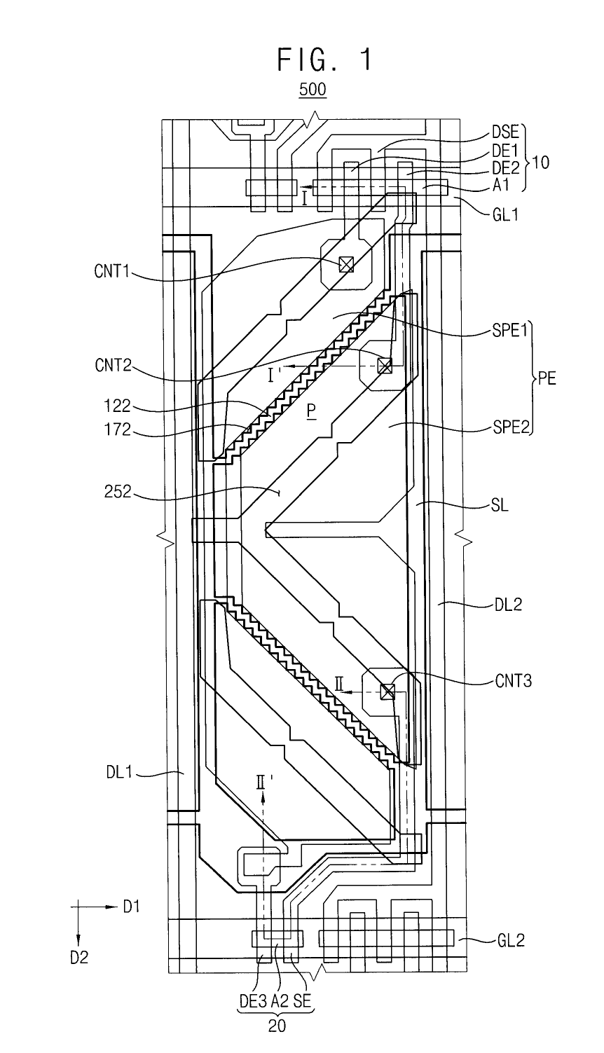

FIG. 1 is a plan view illustrating an exemplary embodiment of a display panel 500 according to the present invention.

FIG. 1 primarily illustrates elements formed on a first base substrate, but also illustrates the positioning of a second opening pattern 252 formed on a second base substrate facing the first base substrate.

Referring to FIG. 1, an exemplary embodiment of a display panel 500 according to the present invention includes first and second gate lines GL1 and GL2, first and second data lines DL1 and DL2, a first switching element 10, a pixel electrode PE having a first opening pattern 1 72 formed therein, and a light-blocking wiring 122. The display panel 500 further includes a storage line SL, a second switching element 20 and a second opening pattern 252.

The first gate line GL1 is extended in a first direction D1 of the display panel 500, and the second gate line GL2 is disposed substantially in parallel with a second direction D2 different from the first direction D1. The first direction D1 may be substantially perpendicular to the second direction D2.

The first data line DL1 is extended in the second direction D2 to cross the first and second gate lines GL1 and GL2. The second data line DL2 is disposed substantially in parallel with the first data line DL1 in the first direction D1. The second data line DL2 also crosses the first and second gate lines GL1 and GL2. Although the data lines DL1 and DL2 cross the gate lines GL1 and GL2, they may be electrically insulated therefrom.

The first switching element 10 is electrically connected to the first gate line GL1 and the second data line DL2. The first switching element 1 0 is turned on by a first gate signal applied to the first gate line GL1. The first switching element 10 is electrically connected to the pixel electrode PE.

The first switching element 10 includes a dual source electrode DSE extending from the second data line and overlapping the first gate line GL1, a first drain electrode DE1 and a second drain electrode DE2. The dual source electrode DSE may form a W-shape. The first drain electrode DE1 and the second drain electrode DE2 are spaced apart from the dual source electrode DSE. The first and second drain electrodes DE1 and DE2 are electrically connected to the pixel electrode PE.

A first active pattern A1 is disposed between the dual source electrode DSE and the first drain electrode DE1 and also between the dual source electrode DSE and the second drain electrode DE2. The first and second drain electrodes DE1 and DE2 are electrically connected to the dual source electrode DSE through the first active pattern Al such that a data signal applied to the second data line DL2 may be transferred to the first and second drain electrodes DE1 and DE2 when the first gate signal is applied to the first gate line GL1.

In one exemplary embodiment, the pixel electrode PE may be disposed within a pixel area P. For example, the pixel electrode PE may be formed in an area bounded by the first and second data lines DL1 and DL2 and the first and second gate lines GL1 and GL2, however the area where the pixel electrode PE is formed may be also be otherwise defined. The pixel area P may have a rectangular shape when viewed from above. The first opening pattern 172 is formed in the pixel area P to form a liquid crystal domain of the pixel area P. The pixel electrode PE includes a first sub-electrode SPE1 and a second sub-electrode SPE2.

The first opening pattern 172 is formed in the pixel area P in an inclined direction with respect to the first and second gate lines GL1 and GL2 as seen from a plan view. The first opening pattern 172 is extended along a third direction, wherein the third direction is disposed between the first direction D1 and the second direction D2. For example, the first opening pattern 172 may extend in a third direction about 45 degrees from the first and second gate lines GL1 and GL2 and the first and second data lines DL1 and DL2. The first opening pattern 172 may have a V-shape or a U-shape that is defined by two diagonal lines.

The first sub-electrode SPE1 may be formed to surround the second sub-electrode SPE2 on at least three sides. The first sub-electrode SPE1 is spaced apart from the second sub-electrode SPE2 by a width of the first opening pattern 172. The first sub-electrode SPE1 makes contact with the first drain electrode DE1 through a first contact hole CNT1. The second sub-electrode SP2 makes contact with the second drain electrode DE2 through a second contact hole CNT2. Therefore, the first and second sub-electrodes SPE1 and SPE2 are electrically connected to the first switching element 10.

The light-blocking wiring 122 is formed in an area where the first opening pattern 172 is formed. In one exemplary embodiment, the light-blocking wiring 122 may be electrically coupled to the storage line SL. The light-blocking wiring 122 is extended in a length direction of the first opening pattern 172 along the first opening pattern 172.

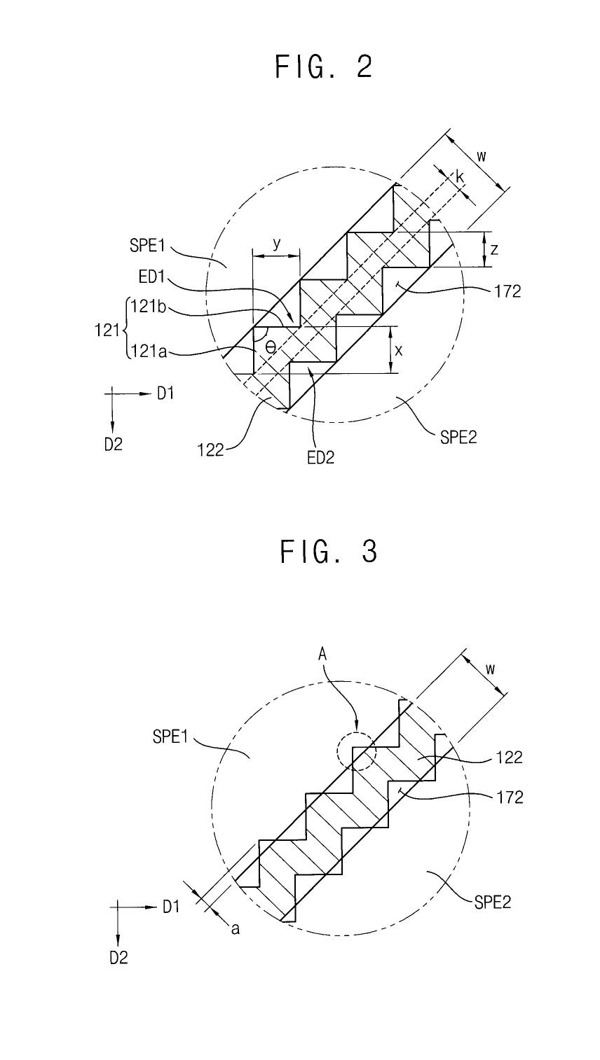

Hereinafter, an exemplary embodiment of a light-blocking wiring 122 according to the present invention will be described in further detail with reference to FIGS. 2 and 3.

FIG. 2 is an enlarged plan view illustrating an exemplary embodiment of a light-blocking wiring of FIG. 1.

Referring to FIGS. 1 and 2, the exemplary embodiment of a light-blocking wiring 122 according to the present invention is formed in an area where the first opening pattern 172 is formed. The light-blocking wiring 122 is extended in a length direction of the first opening pattern 172 along the first opening pattern 172. In one exemplary embodiment, a width of the light-blocking wiring 122 is about 5 μm to about 10 μm.

The light-blocking wiring 122 includes a convex-concave pattern formed at a first edge portion ED1 extended along a length direction of the first opening pattern 172, and a second edge portion ED2 opposite to the first edge portion ED1. The first edge portion ED1 is adjacent to the first sub-electrode SPE1, and the second edge portion ED2 is adjacent to the second sub-electrode SPE2.

The convex-concave pattern includes a plurality of unit shapes 121. The unit shapes 121 are formed by the first and second edge portions ED1 and ED2 to define the convex-concave pattern of the exemplary embodiment of a light-blocking wiring 122 according to the present invention. The unit shapes 1 21 are repeatedly disposed to define the convex-concave pattern. The convex-concave pattern may include a first pattern of the unit shape 121 formed at the first edge portion ED1, and a second pattern of the unit shape 121 formed at the second edge portion ED2. The first and second patterns may be connected to each other when viewed from a plan view. Accordingly, the shape of the exemplary embodiment of a light-blocking wiring 122 according to the present invention may include a substantially zigzag shape. In one exemplary embodiment, a width ‘w’ of the light-blocking wiring 122 may be about 5 μm to 10 μm, and a width ‘k’ of a straight portion of the light-blocking wiring 122, excluding the convex-concave pattern may be about 2 μm to about 4 μm.

The unit shape 121 includes a first slant portion 121a and a second slant portion 121b disposed at an angle to each other. The unit shape 121 may have a convex shape in which the first and second slant portions 121a and 121b are protruded toward an external side of the light-blocking wiring 122, when viewed on a plane. The first slant portion 121a may be extended along the second direction D2, and the second slant portion 121b may be extended along the first direction D1. The first slant portion 121a and the second slant portion 121b may intersect at a crossing point.

Each of a first length ‘x’ of the first slant portion 121a and a second length ‘y’of the second slant portion 121b may be about 4 μm to about 10 μm. Unit shapes having substantially the same area may be repeatedly disposed to define the convex-concave pattern. Alternatively, unit shapes having substantially different areas may be repeatedly disposed to define the convex-concave pattern. For one example, the first and second lengths ‘x’ and ‘y’ of the unit shape may decrease toward a center portion of the pixel electrode PE. For another example, the first and second lengths ‘x’ and ‘y’ of the unit shape may increase toward the center portion of the pixel electrode PE. For one example, the first length ‘x’ and the second length ‘y’ may be substantially equal to each other. For another example, the first length ‘x’ and the second length ‘y’ may be substantially different from each other.

In one exemplary embodiment, a distance ‘z’ may be about 3 μm to about 10 μm, which is defined between the first slant portion 121a of the unit shape formed in the first edge portion ED1 of the light-blocking wiring 122, and the second slant portion 121b of the unit shape formed in the second edge portion ED2 of the light-blocking wiring 122. In one exemplary embodiment, the distance ‘z’ may be equal to the first length ‘x’ and the second length ‘y’. Considering a light blocking function of the light-blocking wiring 122, the distance ‘z’ may be equal to or more than about 3 μm.

A distance between the crossing portion of the first and second slant portions 121a and 121b of the first edge portion ED1 and the crossing portion of the first and second slant portions 121a and 121b of the second edge portion ED2 may be substantially equal to a width ‘w’ of the first opening pattern 172. In one exemplary embodiment, a width ‘w’ of the opening pattern 172 may be about 3.5 μm to about 10 μm.

In one exemplary embodiment, a crossing angle ‘θ’ between the first slant portion 121a and the second slant portion 121b may be about 45 degrees to about 135 degrees. When the crossing angle ‘θ’ is smaller than about 45 degrees or greater than about 135 degrees, the total shape of the light-blocking wiring 122 is a substantially rectangle shape due to the convex-concave pattern formed by the unit shape, so that the liquid crystal is not arranged along a direction of the polarizing axis of the display panel 500.

In one exemplary embodiment, the crossing angle ‘θ’ may be about 60 degrees to about 120 degrees. In one exemplary embodiment, the crossing angle ‘θ’ may be about 90 degrees. According to one exemplary embodiment of the present invention, the liquid crystal molecules may be arranged in a direction of polarizing axes of the display panel 500 by the light-blocking wiring 122.

In one exemplary embodiment, a width “w” of the light-blocking wiring 122 is equal to or less than that of the first opening pattern 172. That is, the first and second edge portions ED1 and ED2 of the light-blocking wiring 122 are closely formed with the first sub-electrode SPE1 and the second sub-electrode SPE2, respectively. In this exemplary embodiment, the light-blocking wiring 122 is not overlapped with the first and second sub-electrodes SPE1 and SPE2.

In an alternative exemplary embodiment, the light-blocking wiring 122 may be overlapped with the pixel electrode PE.

FIG. 3 is an enlarged plan view illustrating a position between an exemplary embodiment of a light-blocking wiring and a pixel electrode of FIG. 2.

Referring to FIG. 3, the first edge portion ED1 overlaps a portion of the first sub-electrode SPE1, and the second edge portion ED2 is overlapped with a portion of the second sub-electrode SPE2. In FIG. 3, ‘A’ denotes a region where overlapping of the first edge portion ED1 and the first sub-electrode SPE2 occur. Hereinafter, the overlapping portion will be described.

The region ‘A’ illustrating an overlapping area where the light-blocking wiring 122 and the pixel electrode PE are overlapped with each other may be used as an auxiliary storage capacitor Cst. The array substrate 100 is designed considering a size of the overlapping area, so that a variation of an electric capacitance may be minimized, which is generated by a misalignment during a manufacturing process of the array substrate 100. For example, in one exemplary embodiment, when a width ‘w’ of the first opening pattern 172 is about 5 μm, a distance ‘a’ between a crossing portion and an end portion of the first sub-electrode SPE1 may be about 1.5 μm to about 1.8 μm. Here, the crossing portion is defined by the first slant portion 121a and the second slant portion 121b.

Referring again to FIG. 1, the storage line SL is formed in the pixel area P. The storage line SL includes portions substantially parallel to the first and second gate lines GL1 and GL2 and portions substantially parallel to the first and second data lines DL1 and DL2. The storage line SL is formed between the first gate line GL1 and the second gate line GL2. In one exemplary embodiment, the storage line SL may include, for example, a U-shape. The storage line SL is overlapped with a portion of the pixel electrode PE. The storage line SL is connected to the light-blocking wiring 122.

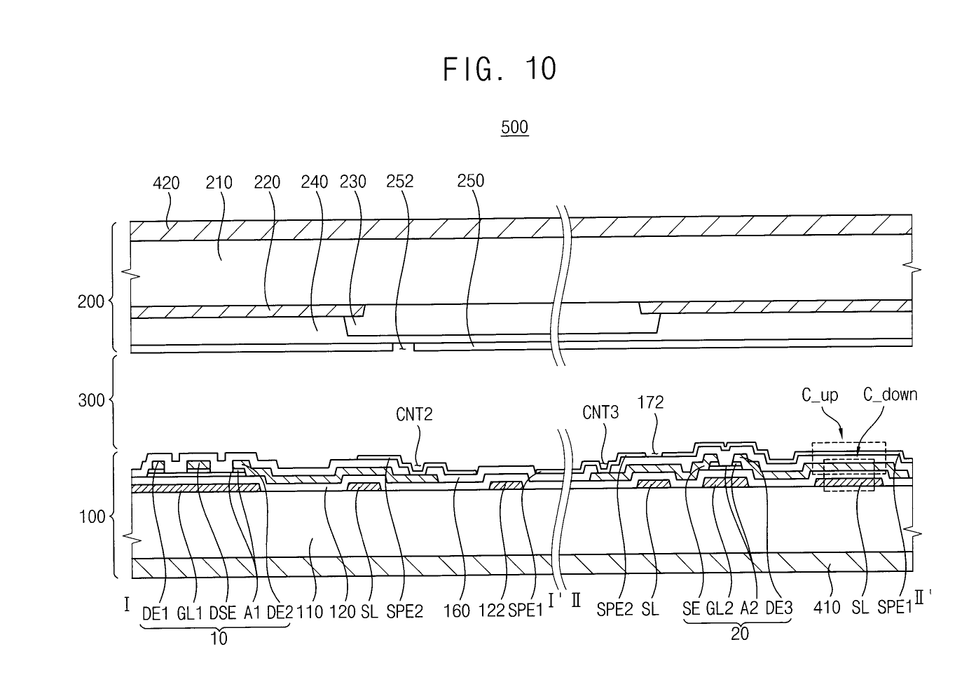

The second switching element 20 is electrically connected to the second gate line GL2 and the storage line SL. The second switching element 20 is turned on by a second gate signal applied to the second gate line GL2. The second switching element 20 includes a source electrode SE and a third drain electrode DE3. The source electrode SE and the third drain electrode DE3 overlap the second gate line GL2. The source electrode SE makes contact with the second sub-electrode SPE2 through a third contact hole CNT3. The third drain electrode DE3 is overlapped with the storage line SL and the first sub-electrode SPE1. The storage line SL and the third drain electrode DE3 may define a voltage down capacitor C_down, and the third drain electrode DE3 and the first sub-electrode SPE1 may define a voltage up capacitor C_up (see following FIG. 10).

A second active pattern A2 is formed on the second gate line GL2. The source electrode SE and the third drain electrode DE3 are formed on the second active pattern A2. The third drain electrode DE3 is electrically connected to the source electrode SE through the second active pattern A2.

The second opening pattern 252 is formed on a common electrode layer (not shown) which is disposed substantially opposite to the pixel electrode PE. The second opening pattern 252 does not directly overlap the first opening pattern 172, thereby forming the liquid crystal domain with the first opening pattern 172. The second opening pattern 252 includes a V-shaped pattern and a diagonal-line shaped pattern surrounding the V-shaped pattern. The first opening pattern 172 may be disposed between the V-shaped pattern and the diagonal-line shaped pattern.

Hereinafter, a process in which different voltages are applied to the first sub-electrode SPE1 and the second sub-electrode SPE2 will be described. A voltage applied to the first sub-electrode SPE1 is defined as a first voltage, and a voltage applied to the second sub-electrode SPE2 is defined as a second voltage.

When the first gate signal is applied to the first gate line GL1, the first voltage of the first sub-electrode SPE1 is substantially equal to the second voltage of the second sub-electrode SPE2, and then the first and second voltages are gradually increased. Then, when the first gate signal is not applied to the first gate line GL1, the first voltage of the first sub-electrode SPE1 is substantially equal to the second voltage of the second sub-electrode SPE2, and then the first and second voltages are gradually decreased and are maintained at a substantially constant voltage.

Then, when the second gate signal is applied to the second gate line GL2, the first voltage of the first sub-electrode SPE1 is gradually increased to be maintained at a constant voltage, however, the second voltage of the second sub-electrode SPE2 is substantially maintained at the value it had before the second gate signal was applied to the second gate line GL2.

Lastly, when the second gate signal is not applied to the second gate line GL2, the first voltage of the first sub-electrode SPE1 and the second voltage of the second sub-electrode SPE2 are maintained at different values from each other. As a result, the first voltage of the first sub-electrode SPE1 is relatively higher than the second voltage of the second sub-electrode SPE2. That is, the first and second sub-electrodes SPE1 and SPE2 receive the same voltage through the first switching element 10, however, the first voltage of the first sub-electrode SPE1 is increased by the second switching element 20, so that the first sub-electrode SPE1 and the second sub-electrode SPE2 may receive substantially different voltages.

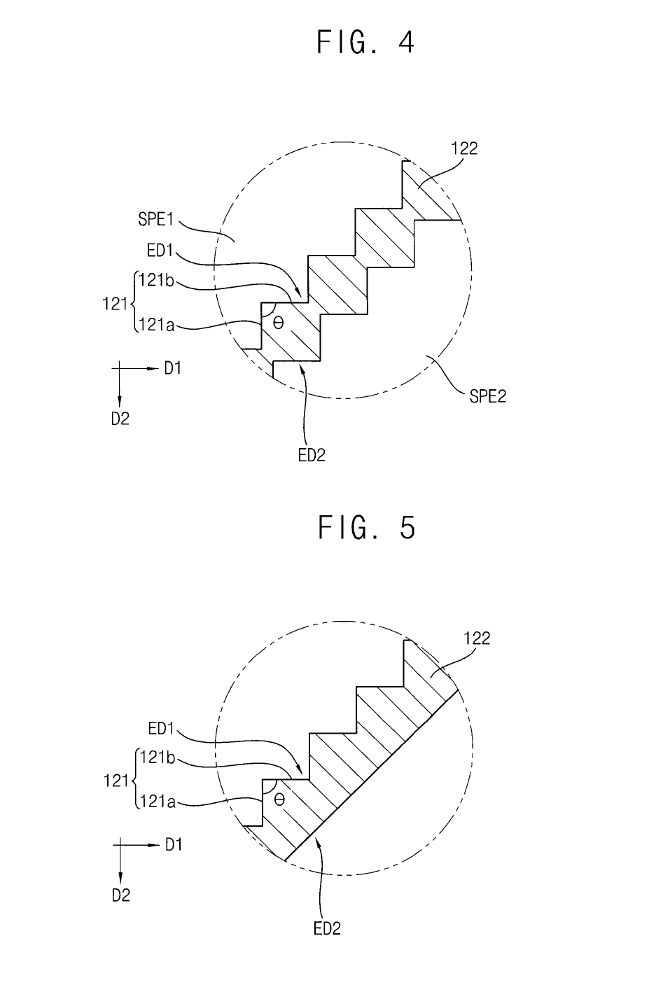

FIGS. 4 to 9 are enlarged plan views illustrating exemplary embodiments of a light-blocking wiring according to the present invention.

A plurality of light-blocking wirings as shown in FIG. 4 may be adopted in the exemplary embodiment of a display panel 500 of FIG. 1. Thus, the same reference numerals will be used to refer to the same or like parts as those described in FIGS. 1 and 2 and any further explanation concerning the above elements will be omitted.

Referring to FIG. 4, one exemplary embodiment of a light-blocking wiring 122 according to the present invention includes a plurality of unit shapes 121 that are continuously and repeatedly disposed on the display panel 500. In the present exemplary embodiment, the unit shape 121 has a substantially convex shape. The light-blocking wiring 122 may include a first pattern of the unit shape 1 21 formed at the first edge portion ED1, and a second pattern of the unit shape 121 formed at the second edge portion ED2. In one exemplary embodiment, the first and second patterns may be substantially symmetrically disposed on the display panel 500.

In one exemplary embodiment, a crossing angle ‘θ’ of the first slant portion 121a and the second slant portion 121b may be about 45 degrees to about 135 degrees. In another exemplary embodiment, the crossing angle ‘θ’ may be about 60 degrees to about 120 degrees. In one exemplary embodiment, the crossing angle ‘θ’ is about 90 degrees.

A plurality of light-blocking wirings as shown in FIGS. 5 to 8 may be adopted in the exemplary embodiment of a display panel 500 of FIG. 1. Thus, the same reference numerals will be used to refer to the same or like parts as those described in FIGS. 1 and 2 and any further explanation concerning the above elements will be omitted.

Referring to FIG. 5, another exemplary embodiment of a light-blocking wiring 122 according to the present invention includes a convex-concave pattern in which a plurality of unit shapes 1 21 are continuously and repeatedly disposed at the first edge portion ED1. In the present exemplary embodiment, the unit shape 121 may have a convex shape.

In the present exemplary embodiment, the first edge portion ED1 of the light-blocking wiring 122 makes contact with an edge portion of the first sub-electrode SPE1 (not shown in FIG. 5), so that the light-blocking wiring 122 may not overlap the first sub-electrode SPE1. In one exemplary embodiment, the second edge portion ED2 may overlap an edge portion of the second sub-electrode SPE2. In an alternative exemplary embodiment, the second edge portion ED2 may not overlap an edge portion of the second sub-electrode SPE2.

In an alternative exemplary embodiment, the first edge portion ED1 of the light-blocking wiring 122 may further include a portion which overlaps with an edge portion of the first sub-electrode SPE1. The overlapping portion may form an electrode for defining an auxiliary storage capacitor. In one exemplary embodiment, the second edge portion ED2 may overlap an edge portion of the second sub-electrode SPE2. In an alternative exemplary embodiment, the second edge portion ED2 may not overlap an edge portion of the second sub-electrode SPE2.

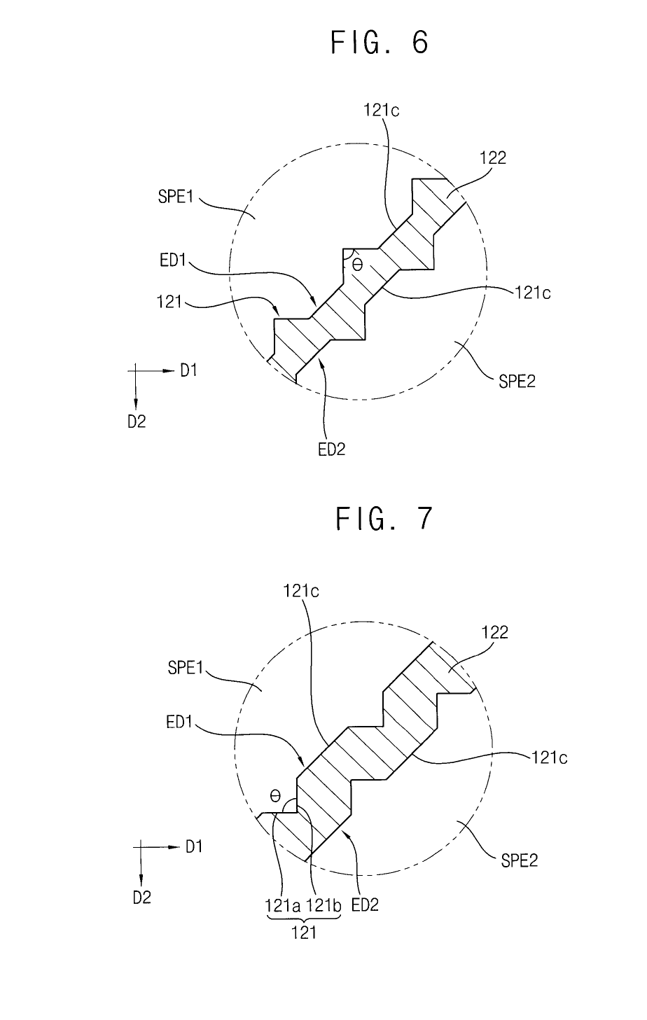

Referring to FIG. 6, still another exemplary embodiment of a light-blocking wiring 122 according to the present invention includes a convex-concave pattern defined by a first pattern and a second pattern. The first pattern is that the unit shapes 121 are continuously and repeatedly disposed at the first edge portion ED1. The second pattern is that the unit shapes 121 are continuously and repeatedly disposed at the second edge portion ED2. The unit shapes 121 may be formed on substantially opposite sides of the concave-convex wiring 122. In the present exemplary embodiment, the first and second pattern of the concave-convex wiring 122 include a plurality of substantially flat sections 121c disposed between unit shapes 121. In one exemplary embodiment unit shapes 121 disposed at the first edge portion ED1 of the convex-concave pattern correspond to flat sections 121c on the second edge portion ED2 and unit shapes 121 disposed at the second edge portion ED2 correspond to flat sections 121c on the first edge portion ED1.

Referring to FIG. 7, still another exemplary embodiment of a light-blocking wiring 1 22 according to the present invention includes a plurality of unit shapes 1 21 disposed on the display panel 500. The unit shape 121 has a concave shape in which the first slant portion 121a and the second slant portion 121b are recessed toward an internal side of the light-blocking wiring 122. In the present exemplary embodiment, the light-blocking wiring 122 includes a first pattern of the unit shape 121 formed at the first edge portion ED1, and a second pattern of the unit shape 121 formed at the second edge portion ED2. In one exemplary embodiment, the unit shapes 121 may include plurality of substantially flat sections 121c disposed between the unit shapes 121 on both edges ED1 and ED2 of the concave-convex wiring 122. In such an exemplary embodiment, the first pattern disposed on the first edge ED1 may be disposed to correspond to flat sections 121c on the second edge ED2 and the second pattern disposed on the second edge ED2 may be disposed to correspond to flat sections 12c on the first edge ED1.

In one exemplary embodiment, a crossing angle ‘θ’ of the first slant portion 121a and the second slant portion 121b may be about 45 degrees to about 135 degrees. In another exemplary embodiment, the crossing angle ‘θ’ is about 60 degrees to about 120 degrees. In another exemplary embodiment, the crossing angle ‘θ’ is about 90 degrees.

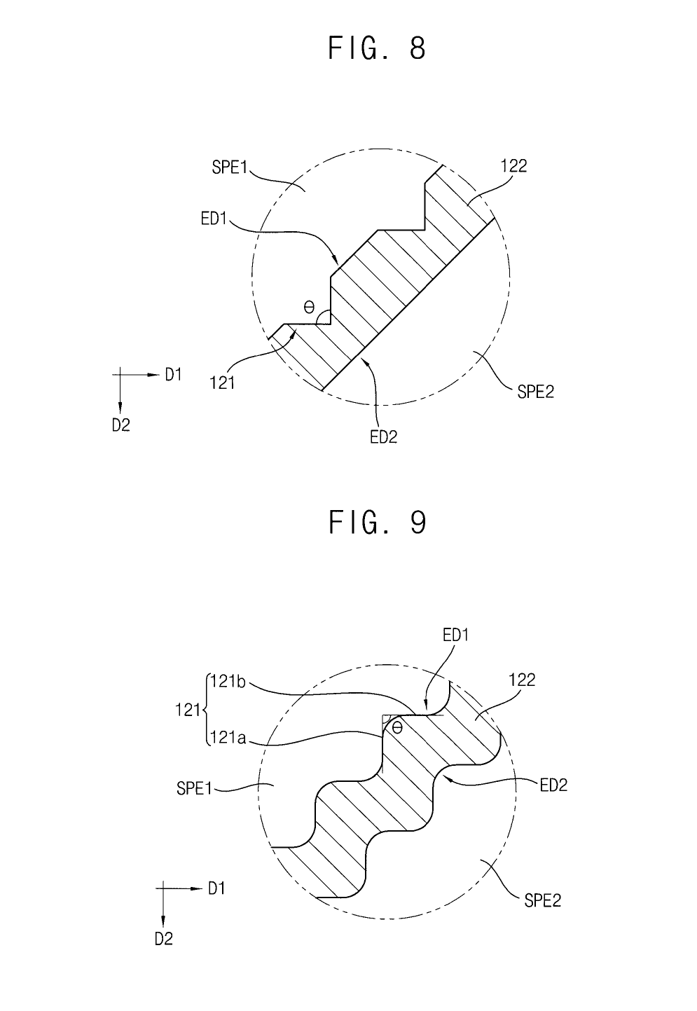

Referring to FIG. 8, still another exemplary embodiment of a light-blocking wiring 122 according to the present invention includes a convex-concave pattern in which a plurality of unit shapes 121 is continuously and repeatedly disposed at the first edge portion ED1. In the present exemplary embodiment, the unit shape 121 has a concave shape.

In FIGS. 5 and 8, the convex-concave pattern is formed at the first edge portion ED1 of the light-blocking wiring 122. In an alternative exemplary embodiment, the convex-concave pattern may be formed at the second edge portion ED2 of the light-blocking wiring 122.

Referring to FIG. 9, a crossing area of the first slant portion 121a and the second slant portion 121b may be rounded. In such an exemplary embodiment, the overall shape of the light-blocking wiring 122 may be a wave shape. The crossing area of the first slant portion 121a and the second slant portion 121b may be rounded by design or as the result of a photolithographic process that forms the light-blocking wiring 122.

Alternative exemplary embodiments of each of the unit shapes 121 of the convex-concave patterns as shown in FIGS. 2 to 8 may be rounded in a crossing portion between the first and second slant portions 121a and 121b, similar to the unit shape of FIG. 9.

According to one exemplary embodiment of the present invention, liquid crystal molecules may be arranged by the light-blocking wiring 122 to be substantially parallel with respect to a direction of a polarizing axis of the display panel 500. Therefore, light leakage may be minimized and a contrast ratio may be enhanced, thereby enhancing display quality.

FIG. 10 is a cross-sectional view taken along line I-I′ and line II-II′ of FIG. 1.

Referring to FIGS. 1 and 10, the exemplary embodiment of a display panel 500 includes an array substrate 100, an opposite substrate 200 and a liquid crystal layer 300. The display panel 500 further includes a first polarizing plate 410 and a second polarizing plate 420.

The array substrate 100 includes the first and second gate lines GL1 and GL2 formed on a first base substrate 110, the first and second data lines DL1 and DL2, the switching element 10, the pixel electrode PE, the light-blocking wiring 122, the storage line SL, the second switching element 20, the first active pattern A1 and the second active pattern A2. The array substrate 11 0 may further include a gate insulation layer 120 formed on the first base substrate 110 and a passivation layer 160 formed on the gate insulation layer 120.

In one exemplary embodiment, the first base substrate 110 may have a substantially flat shape. In one exemplary embodiment, the first base substrate 110 includes a transparent material such as glass, quartz, synthetic resin, or other similar materials.

A gate pattern is formed on the first base substrate 110. The gate pattern includes the first and second gate lines GL1 and GL2, the storage line SL and the light-blocking wiring 122. In one exemplary embodiment, a gate metal layer may be formed on the first base substrate 110, and then the gate metal layer may be patterned through a well-known photolithography process to form the gate pattern.

The gate insulation layer 120 is formed on the first base substrate 110 including the gate pattern. Exemplary embodiments of the gate insulation layer 120 may include, for example, silicon oxide (“SiOx”), silicon nitride (“SiNx”) and other similar materials.

The first and second active patterns A1 and A2 are formed on the gate insulation layer 120. In one exemplary embodiment, the first and second active patterns A1 and A2 may include silicon. In one exemplary embodiment, the first and second active patterns A1 and A2 may include amorphous silicon (“a-Si”) and N+ amorphous silicon (“n+ a-Si”) formed by doping N+ impurities having a high concentration into a silicon base. The first and second active patterns A1 and A2 also include ohmic contact layers discussed in more detail below.

A source pattern is formed on the first base substrate 110 having the first and second active patterns A1 and A2. The source pattern includes the first and second data line DL1 and DL2, and the first and second switching elements 10 and 20. In one exemplary embodiment, a source metal layer is formed on the first base substrate 110 having the first and second active patterns A1 and A2, and the source metal layer is patterned through a photo etching process to form the source pattern. The storage line SL and the third drain electrode DE3 together may define a voltage down capacitor C_down.

The passivation layer 160 is formed on the first base substrate 110 having the source pattern. The first, second and third contact holes CNT1, CNT2 and CNT3 are formed through the passivation layer 160. The first contact hole CNT1 exposes a first end portion of the first drain electrode DE1, the second contact hole CNT2 exposes a first end portion of the second drain electrode DE2, and the third contact hole CNT3 exposes a first end portion of the source electrode SE of the second switching element 20. In one exemplary embodiment, the passivation layer 160 may include silicon oxide (“SiOx”) or silicon nitride (“SiNy”).

The pixel electrode PE is formed on the first base substrate 110 having the passivation layer 160. The pixel electrode PE may include an optically transparent and electrically conductive material. In one exemplary embodiment, the pixel electrode PE includes indium tin oxide (“ITO”), indium zinc oxide (“IZO”), amorphous-indium tin oxide (“a-ITO”) and other similar materials. The third drain electrode DE3 and a first sub-electrode SPE1 of the pixel electrode PE may define a voltage up capacitor C_up.

In one exemplary embodiment, the opposite substrate 200 include a second base substrate 210, a light-blocking pattern 220 formed on the second base substrate 210, a color filter 230 and a common electrode layer 250. In one exemplary embodiment, the second opening pattern 252 is formed on the common electrode layer 250. The opposite substrate 200 may further include an overcoating layer 240.

In one exemplary embodiment, the second base substrate 210 may have a substantially flat shape disposed substantially opposite the first base substrate 110. In one exemplary embodiment, the second base substrate 210 includes a transparent material, exemplary embodiments of which include glass, quartz, synthetic resin and other similar materials.

The light-blocking pattern 220 is formed on the second base substrate 210. In one exemplary embodiment, the light-blocking pattern 220 may be formed on the second base substrate 210 in correspondence with an area where the first and second gate lines GL1 and GL2, the first and second data lines DL1 and DL2, and the first and second switching elements 10 and 20 are formed. In one exemplary embodiment, the light-blocking pattern 220 may include a metal such as chromium (Cr), an organic material or other similar materials. In another exemplary embodiment, the light-blocking pattern 220 may include an ink including various pigments.

The color filter 230 may be formed on the first base substrate 210 in correspondence with the pixel electrode PE. A portion of the color filter 230 may overlap the light-blocking pattern 220. In one exemplary embodiment, the color filter 230 may include an organic material including pigments. In such an exemplary embodiment, the pigments may represent a color such as a red color, a green color, a blue color and other similar colors. In one exemplary embodiment, the color filter 230 may be formed through a photo etching process or an inkjet printing process.

The overcoating layer 240 is formed on the second base substrate 210 to cover the light-blocking pattern 220 and the color filter 230. In one exemplary embodiment, the overcoating layer 240 may include an organic material such as an acrylic resin.

The common electrode layer 250 is formed on the second base substrate 210 having the overcoating layer 240. The common electrode 250 includes the second opening pattern 252. In one exemplary embodiment, the common electrode layer 250 may include an optically transparent and electrically conductive material similar to that of the pixel electrode PE.

The liquid crystal layer 300 is interposed between the array substrate 100 and the opposite substrate 200, and includes liquid crystal molecules (not shown). The liquid crystal molecules may be arranged based on an electric field applied between the pixel electrode PE and the common electrode layer 250. The arranged liquid crystal molecules may control a transmittance of light applied from an external side. The light may be provided from a backlight arranged on a lower portion of the display panel 500.

In one exemplary embodiment, the first polarizing plate 410 is combined with the array substrate 100. The first polarizing plate 410 is attached to a first surface of the first base substrate 110. A second surface of the first base substrate 110 faces the second base substrate 210. The first polarizing plate 410 has a first polarizing axis. In one exemplary embodiment, a direction of the first polarizing axis may be the second direction D2 as shown in FIG. 1. The first slant portion 121a of the unit shape may be angled from about 0 degree to about 45 degrees with respect to the first polarizing axis. For example, the first slant portion 121a may be formed in the first polarizing axis direction. Alternative exemplary embodiments include configurations wherein the first polarizing plate 410 is disposed underneath the array substrate 100 without being combined therewith.

In one exemplary embodiment, the second polarizing plate 420 is combined with the opposite substrate 200 to face the first polarizing plate 410. The second polarizing plate 420 is attached to a first surface of the second base substrate 210. A second surface of the second base substrate 210 faces the first base substrate 110. The second polarizing plate 420 has a second polarizing axis. In one exemplary embodiment, a direction of the second polarizing axis may be substantially perpendicular to a direction of the first polarizing axis. For example, a direction of the second polarizing axis may be the first direction D1 as shown in FIG. 1. In one exemplary embodiment, the second slant portion 121b of the unit shape may be angled from about 0 degree to about 45 degrees with respect to the second polarizing axis. In such an exemplary embodiment, the second slant portion 121b may be slanted to about 45 degrees to about 135 degrees with respect to the first slant portion 121a. For example, the second slant portion 121b may be formed in the second polarizing axis direction.

According to exemplary embodiments of the present invention, liquid crystal molecules may be arranged in a direction of the first polarizing axis and/or a direction of the second polarizing axis by the light-blocking wiring 122. Therefore, light leakage may be minimized and a contrast ratio may be enhanced, thereby enhancing display quality.

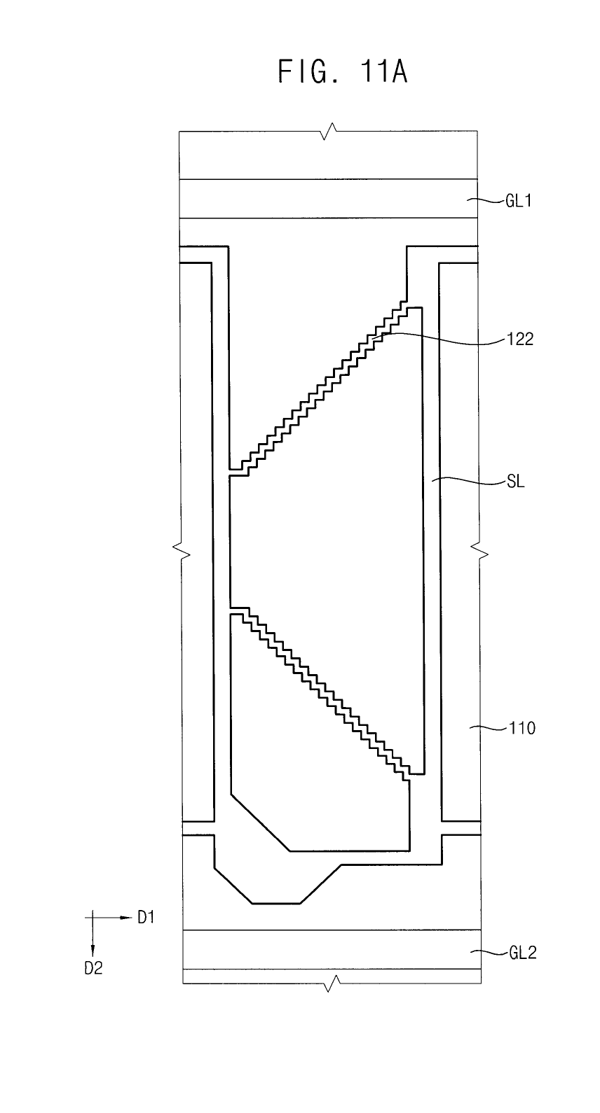

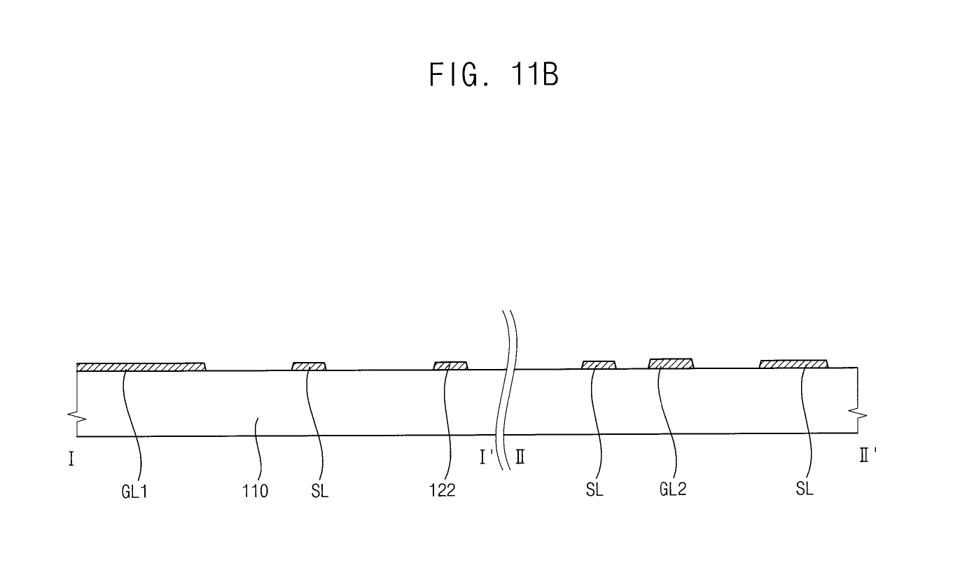

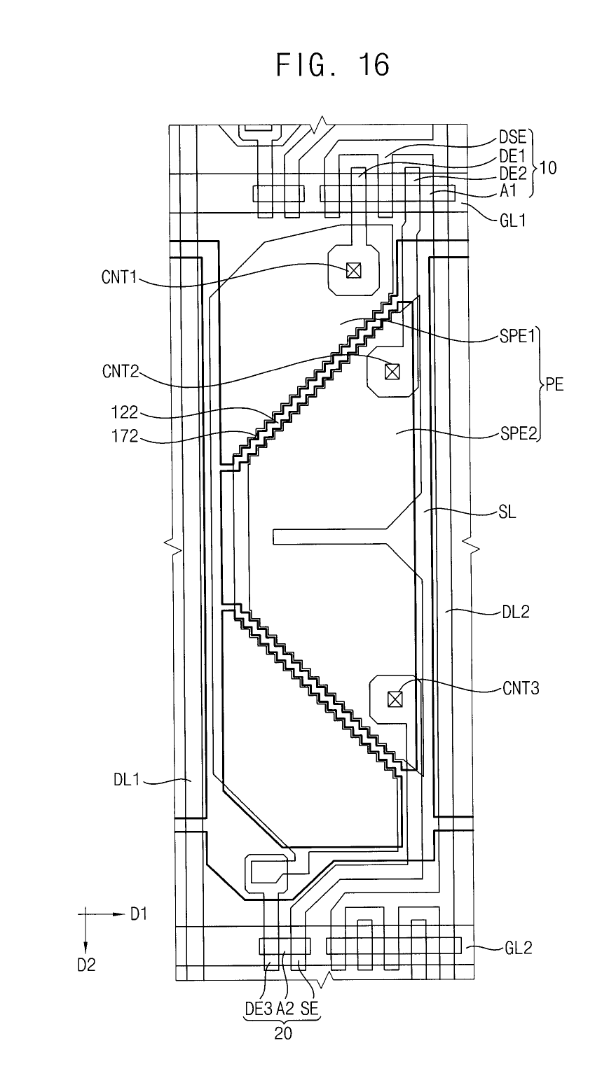

FIGS. 11A and 15 are plan views illustrating an exemplary embodiment of a method of manufacturing an exemplary embodiment of an array substrate of FIGS. 1 and 10. FIGS. 11B, 12, 13 and 14 are cross-sectional views illustrating an exemplary embodiment of an array substrate of FIG. 10.

In FIGS. 11 to 15, the same reference numerals denote the same elements in FIGS. 1 and 10, and thus the detailed descriptions of the same elements will be omitted.

Referring to FIGS. 11A and 11B, a gate pattern is formed on a first base substrate 110. In one exemplary embodiment, a gate metal layer (not shown) is formed on the first base substrate 110. In such an exemplary embodiment, the gate metal layer is patterned through a well-known photolithography process to form the gate pattern. The gate pattern includes the first and second gate lines GL1 and GL2, the storage line SL and the light-blocking wiring 122.

The first gate line GL1 and the second gate line GL2 are substantially in parallel with each other. The storage line SL and the light-blocking wiring 122 are formed between the first gate line GL1 and the second gate line GL2. The light-blocking wiring 122 is formed in a substantially diagonal line direction with respect to the first and second gate lines GL1 and GL2. The light-blocking wiring 122 is connected to the storage line SL.

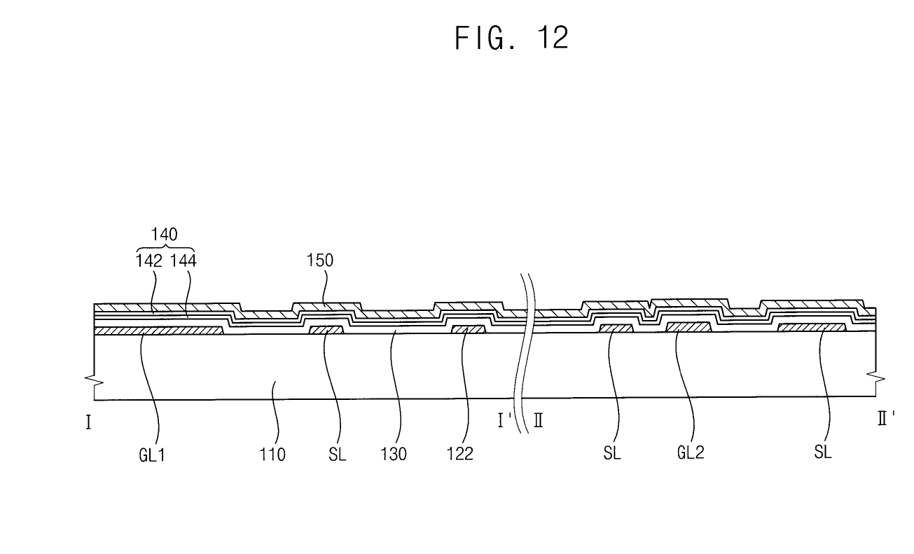

Referring to FIG. 12, a gate insulation layer 120, an active layer 140 and a source metal layer 150 are formed on the first base substrate 110 including the gate pattern.

For example, the gate insulation layer 1 20 is formed on the first base substrate 110 having the gate pattern, so that the gate insulation layer 120 covers the gate pattern.

The active layer 140 is formed on the first base substrate 110 having the gate insulation layer 120. In one exemplary embodiment, the active layer 140 may include a semiconductor layer 142 and an ohmic contact layer 144, wherein the semiconductor layer 142 is disposed on the ohmic contact layer 144. In one exemplary embodiment, the semiconductor layer 142 includes amorphous silicon (“a-Si”), and the ohmic contact layer 144 includes n+ amorphous silicon (“n+ a-Si”). In one exemplary embodiment, n⁺ impurities are doped into the amorphous silicon (“a-Si”) layer at a high concentration to form the ohmic contact 144.

Then, the source metal layer 150 is formed on the first base substrate 110 including the active layer 140.

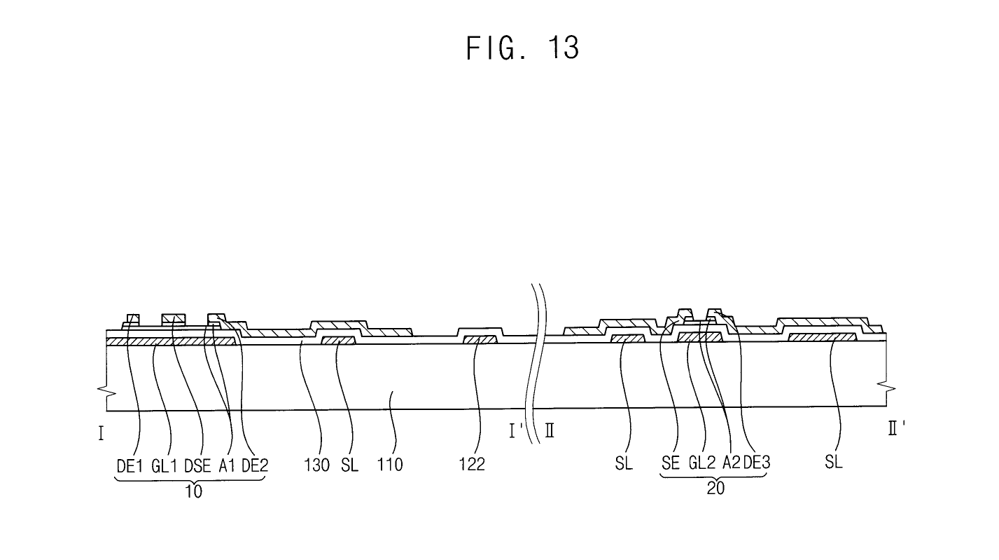

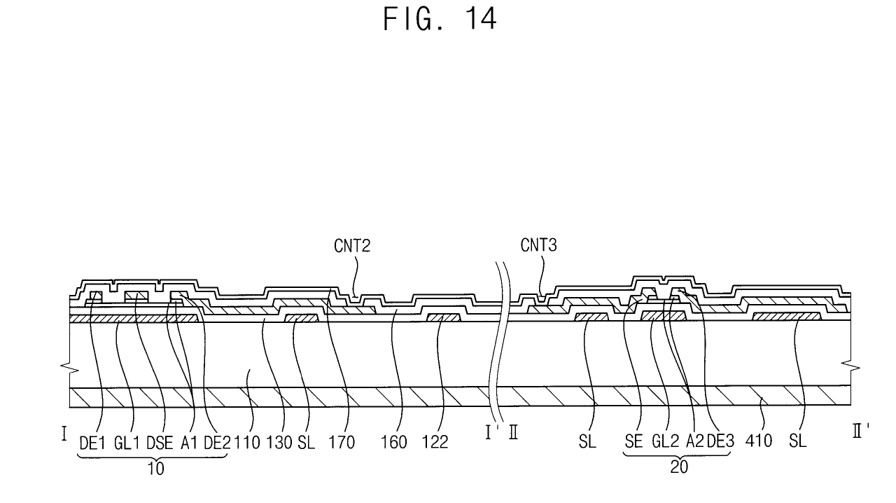

Referring to FIG. 13, a first active pattern A1, a second active pattern A2 and a source pattern are formed on the first base substrate 110.

In one exemplary embodiment, the active layer 140 and the source metal layer 150 are patterned through a photo etching process using one mask including a half-transparent portion and a slit portion, so that the first and second active patterns A1 and A2, and the source pattern may be formed. The source pattern includes a first data line DL1, a second data line DL2, a first switching element 10 and a second switching element 20. In one exemplary embodiment, the first switching element 10 includes a dual source electrode DSE, a first drain electrode DE1 and a second drain electrode DE2, and the second switching element 20 includes a source electrode SE and a third drain electrode DE3.

In one exemplary embodiment, the semiconductor layer 142 of the first active pattern A1 may be exposed between the dual source electrode DSE and the first drain electrode DE1, and may be exposed between the dual source electrode DSE and the second drain electrode DE2. The semiconductor layer 142 of the second active pattern A2 may be exposed between the source electrode SE and the third drain electrode DE3.

In an alternative exemplary embodiment, the first and second active patterns A1 and A2 are formed using one mask, and then the source metal layer 150 is formed. Then, the source metal layer 150 is patterned using the one mask and another mask, so that the source pattern may be formed.

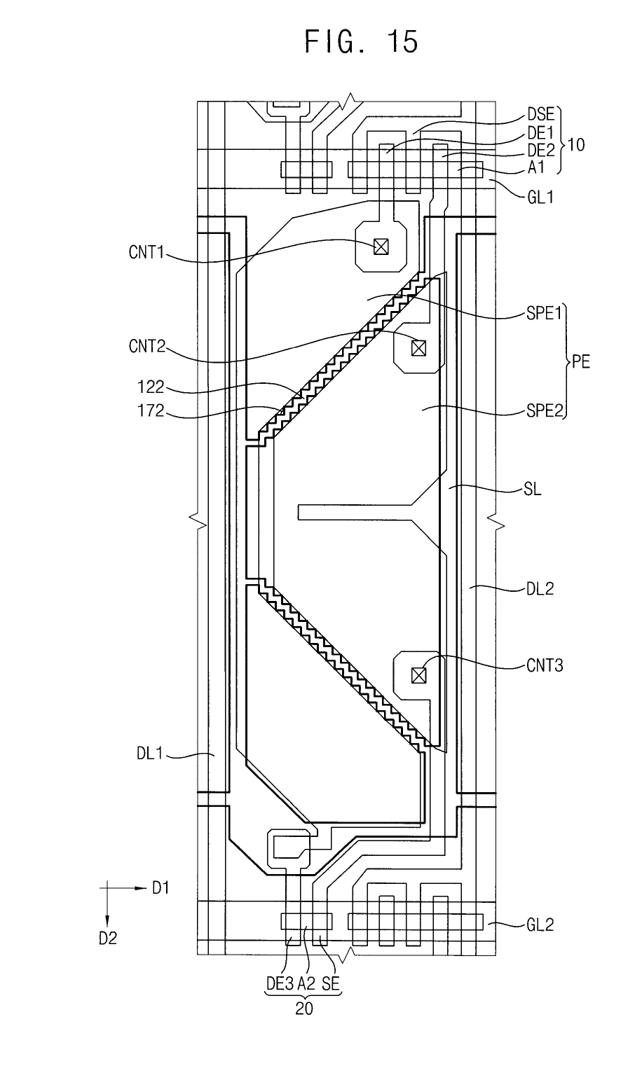

Referring to FIG. 14, a passivation layer 160 and a transparent electrode layer 170 are formed on the first base substrate 110 having the source pattern.

The passivation layer 160 is formed on the first base substrate 110 having the source pattern, and then the passivation layer 160 is patterned to form a first contact hole CNT1, a second contact hole CNT2 and a third contact hole CNT3. In one exemplary embodiment, the patterning may be achieved through a photo etching process.

Then, the transparent electrode layer 170 is formed on the first base substrate 110 having the passivation layer 160. The transparent electrode layer 170 may contact with the first, second and third drain electrodes DE1, DE2 and DE3 through the first, second and third contact holes CNT1, CNT2 and CNT3, respectively.

Referring to FIG. 15, the transparent electrode layer 170 may be patterned to form a pixel electrode PE. In one exemplary embodiment, the patterning may be performed through a photo etching process. The pixel electrode PE includes a first opening pattern 172, a first sub-electrode SPE1, and a second sub-electrode SPE2 spaced apart from the first sub-electrode SPE1 by a width of the first opening pattern 172. The first sub-electrode SPE1 makes contact with the first and second drain electrodes DE1 and DE2, so that the first sub-electrode SPE1 is electrically connected to the first and second switching elements 10 and 20. The second sub-electrode SPE2 makes contact with the source electrode SE, so that the second sub-electrode SPE2 is electrically connected to the first switching element 10.

FIG. 16 is a plan view illustrating another exemplary embodiment of an array substrate according to the present invention.

The exemplary embodiment of an array substrate of FIG. 16 is substantially similar to the array substrate in the display panel of FIG. 1 except for properties of a pixel electrode. Thus, identical reference numerals are used in FIG. 16 to refer to components that are the same or like those shown in FIGS. 1 and 2, and thus, a detailed description thereof will be omitted.

Referring to FIG. 16, the array substrate 100 includes first and second gate lines GL1 and GL2, first and second data lines DL1 and DL2, a first switching element 10, a pixel electrode having a first opening pattern 172 formed thereon, a light-blocking wiring 122, a storage line SL and a second switching element 20.

The light-blocking wiring 122 is formed in a diagonal line direction with respect to the first and second gate lines GL1 and GL2. The light-blocking wiring 122 includes a convex-concave pattern having a plurality of unit shapes in the diagonal line direction. The light-blocking wiring 122 is connected to the storage line SL.

The pixel electrode PE includes a first sub-electrode SPE1, a second sub-electrode SPE2 and a first opening pattern 172. The first sub-electrode SPE1 may be spaced apart from the second sub-electrode SPE2 by the first opening pattern 172. The first opening pattern 172 is formed in an area of the light-blocking wiring 122. Unlike the previous exemplary embodiment, the first opening pattern 172 includes a plurality of convex-concave patterns that are shaped substantially the same as the convex-concave pattern. In one exemplary embodiment, the convex-concave patterns of the first opening pattern 172 may have a one-to-one correspondence with the convex-concave pattern of the light-blocking wiring 122.

As described above, the light-blocking wiring 122 and the first opening pattern 172 having the convex-concave patterns are formed so that liquid crystal molecules may be arranged in a direction of the first polarizing axis and/or a direction of the second polarizing axis by the light-blocking wiring 122. Therefore, light leakage may be minimized and a contrast ratio may be enhanced, thereby enhancing display quality.

Although exemplary embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An array substrate comprising:
a gate line;
a data line crossing the gate line;
a first switching element electrically connected to the gate line and the data line;
a pixel electrode electrically connected to the first switching element, the pixel electrode including an opening pattern; and
a light-blocking wiring disposed in correspondence with the opening pattern, the light-blocking wiring including a convex-concave pattern.

2. The array substrate of claim 1, wherein the opening pattern and the light-blocking wiring are disposed in a diagonal line direction with respect to the gate line, when viewed from a plan view.

3. The array substrate of claim 2, wherein a shape of the opening pattern is substantially equal to that of the light-blocking wiring.

4. The array substrate of claim 2, wherein a width of the opening pattern is about 3.5 μm to about 10 μm.

5. The array substrate of claim 2, wherein the convex-concave pattern is disposed on at least one of a first edge portion of the light-blocking wiring and a second edge portion of the light-blocking wiring substantially opposite to the first edge portion, when viewed from a plan view.

6. The array substrate of claim 5, wherein the convex-concave pattern comprises a unit shape having a convex shape extending away from at least one of the first edge portion of the light-blocking wiring and the second edge portion of the light-blocking wiring substantially opposite to the first edge portion, when viewed from a plan view.

7. The array substrate of claim 5, wherein the convex-concave pattern comprises a unit shape having a concave shape recessed inward from at least one of the first edge portion of the light-blocking wiring and the second edge portion of the light-blocking wiring substantially opposite to the first edge portion, when viewed from a top plan view.

8. The array substrate of claim 5, wherein the convex-concave pattern comprises a unit shape having a first slant portion and a second slant portion disposed at an angle to each other, and
a crossing portion wherein the first slant portion and the second slant portion intersect has one of an angled shape and a rounded shape.

9. The array substrate of claim 8, wherein the angle between the first slant portion and the second slant portion is about 60 degrees to about 120 degrees.

10. The array substrate of claim 8, wherein a length of each of the first and second slant portions is about 5 μm to about 10 μm.

11. The array substrate of claim 8, wherein a width of a straight portion of the light-blocking wiring excluding the convex-concave pattern is about 2 μm to about 4 μm.

12. The array substrate of claim 2, further comprising:
a storage line disposed such that the pixel electrode overlaps at least a portion thereof, the storage line being electrically connected to the light-blocking wiring.

13. The array substrate of claim 12, wherein the pixel electrode comprises a first sub-electrode and a second sub-electrode spaced apart from the first sub-electrode by the opening pattern, and wherein the first sub-electrode is formed to substantially surround the second sub-electrode on at least three sides.

14. The array substrate of claim 13, wherein an edge portion of the light-blocking wiring contacts at least one of an edge portion of the first sub-electrode and an edge portion of the second sub-electrode.

15. The array substrate of claim 13, wherein the light-blocking wiring further comprises an overlapping portion which overlaps at least one of the first sub-electrode and the second sub-electrode.

16. The array substrate of claim 13, wherein the first switching element comprises:
a dual source electrode which overlaps the gate line, the dual source electrode being connected to the data line;
a first drain electrode spaced apart from the dual source electrode, the first drain electrode contacting the first sub-electrode; and
a second drain electrode spaced apart from the dual electrode, the second drain electrode contacting the second sub-electrode.

17. The array substrate of claim 16, further comprising:
a second switching element including a source electrode which contacts the second sub-electrode and a third drain electrode which is overlapped by the first sub-electrode.

18. An array substrate comprising:
first and second gate lines disposed on a base substrate;
a data line crossing the first and second gate lines;
a pixel electrode, including a first sub-electrode and a second sub-electrode spaced apart from the first sub-electrode by an opening pattern formed in a diagonal direction with respect to the first and second gate lines;
a storage line overlapped by the first and second sub-electrodes, wherein sections of the storage line are disposed substantially in parallel with one of the first and second gate lines and the data line;
a light-blocking wiring disposed in correspondence with the opening pattern, wherein the light-blocking wiring is electrically connected to the storage line, the light-blocking wiring including a concave-convex pattern;
a dual switching element electrically connected to the first gate line and the data line, the dual switching element including a first drain electrode which contacts the first sub-electrode and a second drain electrode which contacts the second sub-electrode; and
a switching element electrically connected to the second gate line and the data line, the switching element including a source electrode which contacts the second sub-electrode and a third drain electrode which is overlapped by the first sub-electrode.

19. A display panel comprising:
an array substrate including:
a switching element electrically connected to a gate line disposed on a base substrate and a data line disposed on the base substrate;
a pixel electrode electrically connected to the switching element, the pixel electrode having a first opening pattern formed thereon in a diagonal line with respect to the gate line; and
a light-blocking wiring disposed in correspondence with the opening pattern, the light-blocking wiring including a concave-convex pattern having a first slant part and a second slant part disposed at an angle to each other; and
an opposite substrate disposed substantially opposite to the array substrate, the opposite substrate including a common electrode having a second opening pattern formed thereon, wherein the second opening pattern defines a liquid crystal domain with the first opening pattern.

20. The display panel of claim 19, wherein the angle between the first slant portion and the second slant portion is about 60 degrees to about 120 degrees.

21. The display panel of claim 20, further comprising:
a first polarizing plate attached to the array substrate, the first polarizing plate having a first polarizing axis; and
a second polarizing plate attached to the opposite substrate, the second polarizing plate having a second polarizing axis substantially perpendicular to the first polarizing axis,
wherein the first slant portion is disposed at an angle of about 0 degrees to about 45 degrees with respect to the first polarizing axis, and the second slant portion is disposed at an angle of about 0 degree to about 45 degrees with respect to the second polarizing axis.
